(19) United States
(12) Patent Application Publication
(10) Pub. No.: US 2004/0166036 A1
(43) Pub. Date: Aug. 26, 2004

(54) Catalytic converter system for internal combustion engine powered vehicles

(75) Inventors: Shau-Lin F. Chen, Piscataway, NJ (US); Ronald M. Heck, Frenchtown, NJ (US); Zhicheng Hu, Edison, NJ (US); Michel Deeba, North Brunswick, NJ (US)

Correspondence Address: Chief Patent Counsel, Engelhard Corporation, 101 Wood Avenue, P.O. Box 770, Iselin, NJ, 08830-0770, US

(73) Assignee: ENGELHARD CORPORATION

(21) Appl. No.: 10/783,805

(22) Filed: Feb. 20, 2004

Related U.S. Application Data
(63) Continuation of application No. 08/997,774, filed on Dec. 24, 1997, now abandoned.

(51) Int. Cl. B01D 53/34

(52) U.S. Cl. 422/180; 422/177; 422/171; 423/210

(57) ABSTRACT

A catalyst system combining a low temperature conversion catalyst (LTC), a hydrocarbon adsorbent and, optionally, a three-way catalyst (TWC), is designed to achieve an ultra low vehicle emission standard for internal combustion engine powered vehicles, while never exposing the low temperature conversion catalyst to a temperature in excess of about 550° C.

### BACKGROUND OF THE INVENTION

1. Field of the Invention

The present invention relates to an improved catalytic converter system for the treatment of the exhaust gases from internal combustion engine powered vehicles, and to methods of making and using the same. More specifically, the invention is concerned with catalytic converter systems comprising the combination of a hydrocarbon adsorbent material or “trap” and a low light-off temperature, precious metal catalyst disposed under the floor of an internal combustion engine powered vehicle at the muffler position or at the tailpipe position, where the temperature of the exhaust gas contacting the catalyst will be lower than about 550° C., and preferably lower than about 500° C. The invention is also concerned with catalytic converter systems which combine a hydrocarbon adsorbent material and a low light-off temperature catalyst material so as to achieve ultra low level's of emissions for internal combustion engine powered vehicles, especially during the cold-start period of operation.

2. Discussion of Related Art

Gaseous waste products resulting from the combustion of hydrocarbonaceous fuels, such as gasoline and fuel oils, comprise carbon monoxide, hydrocarbons and nitrogen oxides as products of combustion or incomplete combustion, and pose a serious health problem with respect to pollution of the atmosphere. While exhaust gases from hydrocarbonaceous or other carbonaceous fuel-burning sources, such as stationary engines, industrial furnaces, and the like, contribute substantially to air pollution, the exhaust gases from internal combustion engine powered vehicles, especially automobiles, are a principal source of pollution. Because of these health problem concerns, state and federal agencies, notably the Environmental Protection Agency (EPA), have promulgated strict controls on the amounts of carbon monoxide, hydrocarbons and nitrogen oxides which automobiles can emit. The implementation of these controls has resulted in the use of catalytic converters to reduce the amount of pollutants emitted from automobiles.

In order to achieve the simultaneous conversion of carbon monoxide, hydrocarbon and nitrogen oxide pollutants, it has become the practice to employ catalysts of the type generally referred to as “three-way conversion” (TWC) catalysts. These TWC catalysts are polyfunctional in that they have the capability of substantially simultaneously catalyzing the oxidation of hydrocarbons and carbon monoxide and the reduction of nitrogen oxides.

Known TWC catalysts which exhibit good activity and long life generally comprise one or more platinum group metals (e.g., platinum or palladium, rhodium, ruthenium and iridium) located upon a high surface area, refractory oxide support, e.g., a high surface area alumina coating. The support is carried on a suitable carrier or substrate such as a monolithic carrier comprising a refractory ceramic or metal honeycomb structure, or refractory particles such as pellets, spheres, rings or short, extruded segments of a suitable refractory material.

Many prior art TWC catalyst compositions have been described in the patent literature. For example, U.S. Pat. Nos. 4,476,246, 4,591,578 and. 4,591,580 disclose three-way conversion catalyst compositions comprising alumina, ceria, an alkali metal, oxide promoter and noble metals. U.S. Pat. Nos. 3,993,572 and 4,157,316 represent attempts to improve the catalyst efficiency of Pt/Rh based TWC systems by incorporating a variety of metal oxides, e.g., rare earth metal oxides such as ceria and base metal oxides such as nickel oxides. U.S. Pat. No. 4,591,578 discloses a catalyst comprising an alumina support with components deposited thereon consisting essentially of a lanthana, ceria, an alkali metal oxide and a platinum group metal. U.S. Pat. No. 4,591,580 discloses an alumina supported platinum group metal catalyst. The support is sequentially modified to include support stabilization by lanthana or lanthana rich rare earth oxides, double promotion by ceria and base metal oxides and optionally nickel oxide.

U.S. Pat. No. 4,294,726 discloses a TWC catalyst composition containing platinum and rhodium obtained by impregnating a gamma alumina carrier material with an aqueous solution of cerium, zirconium and iron salts, or mixing the alumina with oxides of, respectively, zirconium cerium and iron. The impregnated carrier is then calcined at 500 to 700° C. in air. The resulting ceria-zirconia-iron oxide treated material is then impregnated with an aqueous solution of a salt of platinum and a salt of rhodium, then dried, and finally treated in a hydrogen-containing gas at a temperature of from 250 to 650° C. The alumina may be thermally stabilized with calcium, strontium, magnesium or barium compounds.

U.S. Pat. No. 4,780,447 discloses a catalyst which is capable of controlling HC, CO and NOₓ, as well as H₂S, in automobile emissions. The use of the oxides of nickel and/or iron is disclosed as an H₂S gettering compound.

Japanese disclosure Number H2-56247, entitled, “Catalyst for Cleansing of Exhaust Gas”, also discloses a catalyst for controlling the emission of hydrocarbons, carbon monoxide and nitrogen oxide. The catalyst comprises a carrier or support, such as a ceramic monolith, on which is deposited a first catalytic layer having a zeolite as its main component, and a second catalytic layer, overlying the first catalytic component, having noble metal as it main component. The catalyst described in this Japanese publication is said to be maximally effective in he exhaust temperature range of 300° C.-800° C.

U.S. Pat. No. 4,965,243 discloses a method for improving the thermal stability of a TWC composition containing precious metals by incorporating a barium compound and a zirconium compound together with ceria and alumina. This is disclosed to form a catalytic moiety to enhance stability of the alumina washcoat upon exposure to high temperature.

Other patents which relate generally to TWC catalysts and to their use in reducing internal combustion engine powered vehicle emissions include U.S. Pat. No. 4,504,598; which discloses a process for producing a high temperature resistant TWC catalyst. The process includes forming an aqueous slurry of particles of gamma or other activated alumina and impregnating the alumina with soluble salts of selected metals including cerium, zirconium, at least one of iron and nickel, at least one of platinum, palladium and rhodium and, optionally, at least one of neodymium, lanthanum, and praseodymium. The impregnated alumina is calcined at 600° C. and then dispersed in water to prepare a slurry which is coated on a honeycomb carrier and dried to obtain a finished catalyst.

Exhaust gas conversion catalysts generally perform efficiently only after they have been heated. Accordingly, it has been standard practice to locate TWC catalysts under the floor of an internal engine powered vehicle, slightly downstream of the engine, where the hot exhaust gases (typically well in excess of about 750° C.) which contact the catalyst will raise the temperature thereof to a point where the catalyst will function efficiently. In order to compare one catalyst with another in terms of the temperatures at which the respective catalysts are able to convert-efficiently the pollutants with which they come in contact, it has been standard practice to categorize such catalysts by their light-off temperature (T_{L}), i.e., the temperature at which a given catalyst attains fifty percent conversion of the pollutants introduced to the catalyst. While significant efforts have been expended to develop exhaust gas conversion catalysts having a low T_{L} (see, e.g., International Publication WO 96/17671, published Jun. 13, 1996, entitled, “CLOSE COUPLED CATALYST”, the disclosure of which is incorporated herein by reference), the T_{L} of conversion catalysts typically is at least about 300° C. to about 400° C. What this means is that during the cold-start period of an engine, and in particular an automobile engine, the temperature of the engine and its exhaust gases are below the temperatures at which the catalyst used to convert the exhaust stream pollutants to innocuous substances, e.g., water and carbon dioxide, will be performing efficiently. Generally, the cold-start period lasts for several minutes from the time an engine at ambient temperature is started, after which time the quantity of hydrocarbons and other pollutants in the exhaust gas is substantially reduced. A recognized industry procedure for measuring cold-start emissions is the Federal Test Procedure found at 40 CFR Part 86 Sections 115-178. The test, which is commonly referred to as FTP Cold-Start Emissions Test, generally involves starting an engine from a cold-start and measuring the emissions for a period of 505 seconds through various modes of engine operation, including idle, acceleration and deceleration.

Due primarily to the inefficiency of conversion catalysts during the cold-start period, current state of the art catalysts are not able to provide ultra low emissions of hydrocarbons and other pollutants, as will be required by California (these standards most probably will be promulgated nationwide).

In order to improve the emissions performance achievable by conversion catalyst compositions, particularly during cold-start operation, it has been proposed to heat the catalyst other than by simply passing very hot exhaust gases over the catalyst. For example, it has been proposed to electrically heat conversion catalysts during at least the first few minutes of operation after starting a cold engine. It also has been proposed to use an adsorbent material to adsorb hydrocarbons during the cold-start period of engine operation. The adsorbent material typically would be located downstream of a TWC catalyst such that the exhaust stream would first flow through the catalyst material and then through the adsorbent material. The adsorbent, often referred to as a “trap”, preferentially would adsorb hydrocarbons over water under the conditions present in the exhaust stream. After a period of time the adsorbent would have reached a temperature, e.g., about 150° C., at which it no longer would be able to adsorb hydrocarbons from the exhaust stream. At that temperature, referred to as the desorption temperature (T_{D}), hydrocarbons would begin to desorb from the adsorbent and would be directed into contact with the conversion catalyst. The desorbed hydrocarbons then would be converted by the heated catalyst. The desorption of the hydrocarbons from the adsorbent material regenerates the adsorbent for use during a subsequent cold start.

Materials which are known to adsorb hydrocarbons include, for example, molecular sieve materials, preferably those which are hydrothermally stable and have a Si:Al ratio of at least about 10 and a hydrocarbon selectivity greater than 1. Examples of molecular sieves that meet these criteria are silicalite, faujasites, clinoptilolites, mordenites an chabazite.

A number of patents disclose the broad concept of using an adsorbent bed to minimize hydrocarbon emissions during a cold start engine operation. One such patent is U.S. Pat. No. 3,699,683 in which an adsorbent bed is placed after both a reducing catalyst and an oxidizing catalyst. That patent discloses that when the exhaust gas stream is below 200° C., the gas stream is flowed through the reducing catalyst then through the oxidizing catalyst and finally through the adsorbent bed, thereby adsorbing hydrocarbons on the adsorbent bed. When the temperature goes above 200° C. the gas stream which is discharged from the oxidation catalyst is divided into a major and minor portion. The major portion is discharged directly into the atmosphere. The minor portion is passed through the adsorbent bed, whereby unburned hydrocarbons are desorbed, and the resulting minor portion containing the desorbed unburned hydrocarbons is then passed into the engine where the desorbed unburned hydrocarbons are burned.

Another patent, U.S. Pat. No. 2,942,932, teaches a process for oxidizing carbon monoxide and hydrocarbons that are contained in exhaust gas streams. The process disclosed in that patent consists of flowing an exhaust stream which is below about 425° C. into an adsorption zone, which adsorbs the carbon monoxide and hydrocarbons, and then passing the resultant stream from the adsorption zone into, an oxidation zone. When the temperature of the exhaust gas steam reaches about 425° C., the exhaust stream-no longer is passed through the adsorption zone, but is passed directly to the oxidation zone with the addition of excess air.

Another patent, Canadian Patent No. 1,205,980, discloses a method of reducing exhaust emissions from an alcohol fueled automotive vehicle. This method consists of directing the cool engine start-up exhaust gas through a bed of zeolite particles and then over an oxidation catalyst. The gas is then discharged to the atmosphere. As the exhaust gas stream warms up, it is passed continuously over the adsorption bed and then over the oxidation bed.

Still another patent disclosing the use of both an adsorbent material and a catalyst composition to treat an automobile engine exhaust stream, especially during the cold-start period of engine operation, is U.S. Pat. No. 5,078,979. That patent discloses the use of a hydrothermally stable molecular sieve adsorbent having a Si:Al ratio of at least 24 and a hydrocarbon selectivity of greater than 1, i.e., the molecular sieve is more adsorbent of hydrocarbons than of water. Molecular sieve materials that are disclosed in that patent include zeolite Y, ultra stable zeolite. Y and ZSM-5. As disclosed, starting at column 7, line 2-9, one or more catalytic metals, e.g., platinum, palladium, rhodium, ruthenium and mixtures thereof, optionally, may be dispersed onto the adsorbent.

Yet another patent disclosing the use of a hydrocarbon absorbent in the treatment of an engine exhaust gas is U.S. Pat. No. 5,510,086. That patent relates to a catalytic converter system that has three catalyst zones. The first zone in line with the direction of exhaust gas flow preferably comprises a palladium-containing catalyst. The second zone in line with the direction of the exhaust gas flow includes a hydrocarbon adsorber/catalyst. The third zone in line with the exhaust gas flow includes a catalyst system for converting CO and NOₓ. The three-zone system is said to produce high hydrocarbon efficiencies and to retain hydrocarbon efficiencies above 50% in cold performance situations.

While the use of hydrocarbon adsorbent materials in combination with catalyst compositions has been proposed, there remains a need for improved integrated adsorbent/catalyst systems which are capable of reducing noxious emissions from internal combustion engine powered vehicles, especially automobiles, while being located relative to the vehicle engine such that the catalyst-never reaches a temperature in excess of about 550° C., preferably such that the catalyst never reaches a temperature in excess of about 500° C., and most preferably such that the catalyst never reaches a temperature in excess of about 480° C. This will enable the use of more economical materials of construction for the converter system components and will increase the useful life of temperature sensitive catalyst materials.

### SUMMARY OF THE INVENTION

In view of the continuing need for improved catalyst systems, it is an object of the invention to design an ultra low emission catalytic converter system for use with engines operated on hydrocarbonaceous fuels.

It is another object to provide a catalytic converter system for use with internal combustion engines that will permit vehicles powered with such engines to meet state and federally mandated vehicle emission standards;

It is yet another object to provide a cost-effective method for meeting stringent vehicle emission standards set by state and federal regulatory authorities and by automobile manufacturers for gasoline and diesel powered vehicles.

These and other objects and advantages of the present invention are achieved by providing a catalytic converter system which combines at least one low light-off temperature precious metal conversion catalyst and a hydrocarbon adsorbent or trap selectively arranged downstream of an internal combustion engine such that the catalyst material never is exposed to a temperature in excess of about 550° C. Preferably, the catalyst is never exposed to a temperature in, excess of about 500° C.; and most preferably, the catalyst is never exposed to a temperature above about 480° C.

In one aspect, the invention comprises a catalytic converter system which includes a three-way conversion (TWC) catalyst, an adsorbent or trap which has a hydrocarbon selectivity of greater than 1, and a low temperature conversion (LTC) catalyst, i.e., a conversion catalyst having a light-off temperature of less than about 200° C.; and preferably, less than about 100° C., e.g., about 70° C.

In another aspect, the invention comprises a catalytic converter system comprising a first, conventional three-way conversion catalyst (TWC) located downstream, but close to an internal combustion engine, a hydrocarbon adsorption trap located downstream of the first catalyst, and a low temperature conversion (LTC) catalyst located downstream of the first conversion catalyst.

In another aspect of the invention, there is provided a catalytic converter system which is designed to be mounted under the floor of an internal combustion engine powered vehicle in the muffler or tailpipe position where the temperature of the engine exhaust is less than about 550° C., and which is comprised of a LTC catalyst and a hydrocarbon trap supported on one or more structural carriers. In still other aspects, as hydrocarbon trap and a LTC catalyst will be supported on a refractory, honeycomb-type carrier, either in separate layers or in a single layer containing both the hydrocarbon trap and the LTC catalyst.

### BRIEF DESCRIPTION OF THE DRAWING

FIG. 1 is a schematic view illustrating an engine of an internal combustion engine powered vehicle, a conventional conversion catalyst located downstream of the engine, a muffler located downstream of the conversion catalyst and a tailpipe-located downstream of the muffler.

FIG. 2 is a schematic view of a catalytic converter system in accordance with a first embodiment of the invention, illustrating an optional, although preferred, hydrocarbon trap, and a low temperature conversion catalyst located downstream of the engine of an internal combustion engine powered vehicle at a position at or near the normal muffler position, where the temperature of the engine exhaust gas stream is less; than about 550° C.;

FIG. 3 is a schematic view of a catalytic converter system in accordance with a second embodiment of the invention, illustrating an optional, although preferred, hydrocarbon trap, and a low temperature conversion catalyst located downstream of the engine of an internal combustion engine powered vehicle at a position at or near the normal tailpipe position, where the temperature of the engine exhaust gas stream is less than about 300° C.;

FIG. 4 is a perspective view of a honeycomb-type refractory carrier member for use in accordance with one embodiment of the invention;

FIG. 5 is a partial cross-sectional view of the honeycomb carrier member of FIG. 4, enlarged relative to FIG. 4, and taken along a plane coincidental with line 5-5, showing a washcoat material thereon; and

FIG. 6 is a partial cross-sectional view of a honeycomb-type carrier in accordance with one embodiment of the invention, comprising a carrier member of the type illustrated in FIG. 4, in a view greatly enlarged relative to FIG. 4, illustrating a plurality of washcoat materials thereon.

### DETAILED DESCRIPTION

The invention comprises a catalytic converter system for reducing the emissions from an internal combustion engine powered vehicle to ultra low levels. As used in this specification and in the appended claims, the term “ultra low levels” of emissions is meant to describe emission standards of Low Emission Vehicle and Ultra-Low Emission Vehicle defined by the California Air Resource Board.

The catalytic converter system comprises a hydrocarbon adsorbent material and a conversion catalyst having a low light-off temperature, i.e., less than about 200° C., and preferably less than about 100° C., e.g., about 70° C., arranged in a manner that utilizes their individual characteristics to achieve a complete or nearly complete conversion of the pollutants in the engine exhaust gas stream to innocuous compounds, such as carbon dioxide, water and nitrogen, while never subjecting the conversion catalyst to temperatures in excess of about 550° C., preferably less than about 500° C., and most preferably less than about 480° C.

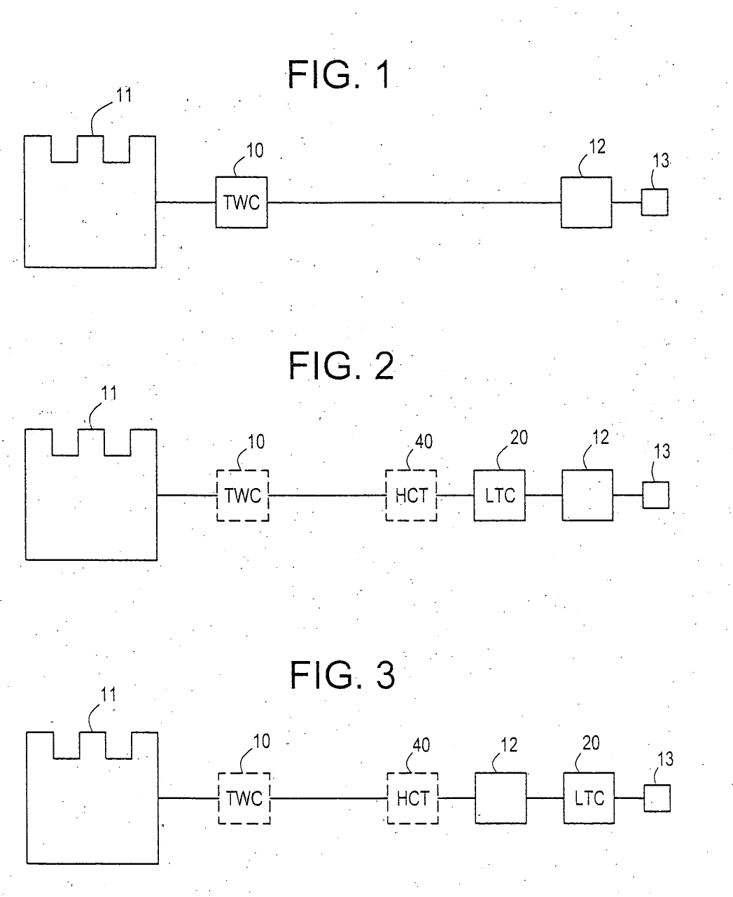

As illustrated schematically in FIG. 1, it is conventional practice to locate a pollutant conversion catalyst 10 under the floor of an internal combustion engine powered vehicle, such as an automobile, at a location downstream of the engine 11 and considerably upstream of a muffler 12 and tailpipe 13. Conversion catalyst 10 preferably comprises a catalyst material also referred to as a first or upstream catalyst material which is preferably a TWC catalyst composition. The catalyst material is preferably supported on a substrate such as a ceramic or metal honeycomb monolith. The conversion catalyst will be contacted with an engine exhaust gas stream having a temperature typically in excess of about 650° C., e.g., about 1000° C. and containing noxious components or pollutants including unburned or thermally degraded hydrocarbons or other similar organics. Other noxious components usually present in the exhaust gas stream include nitrogen oxides and carbon monoxide. The engine 11 may be fueled by a hydrocarbonaceous fuel, which in this specification and in the appended claims, is meant to include hydrocarbons, alcohols and mixtures thereof. Examples of hydrocarbons which may be used to fuel the engine include gasoline and diesel fuel. Alcohols that may be used to fuel the engine include, for example, ethanol and methanol. Mixtures of alcohols and mixtures of alcohols and hydrocarbons also may be used.

When the engine 11 is started up cold, it produces a relatively high concentration of hydrocarbons and other pollutants in the engine exhaust gas stream. In this specification and claims, the term “pollutants” is used to refer collectively to any unburned fuel components and to combustion products found in the exhaust gas stream, including hydrocarbons, nitrogen oxides, carbon monoxide, sulfur oxides and other combustion products. After start-up (and/or while the engine is warming-up), the temperature of the exhaust stream is relatively low, generally below about 500° C., and typically in the range of from about 200° C. to 400° C. The exhaust stream has the above characteristics during the initial or warm-up period of engine operation, typically for the first 30 to 120 seconds after a cold start-up. The engine exhaust stream typically will contain, by volume, about 500 to 1000 ppm hydrocarbons.

During this cold-start period, the temperature of the first catalyst material of conversion catalyst 10 generally is below its light-off temperature (T_{L}), i.e., the temperature at which the catalyst material attains fifty percent conversion performance. Accordingly, during the cold-start period, a substantial portion of the pollutants in the exhaust gas stream typically pass directly through the catalyst 10 and out of the tailpipe 13 and into the atmosphere.

In accordance with one embodiment of the present invention, as illustrated schematically in FIG. 2, a precious metal, low temperature conversion (LTC) catalyst 20, comprising a low temperature conversion, catalyst material having a light-off temperature below about 200° C., and preferably below about 100° C., e.g., about 70° C. The low temperature catalyst material is preferably supported-on a substrate such as a ceramic or metallic honeycomb monolith. The LTC catalyst 20 is located downstream of an internal combustion engine 11 to avoid emitting unconverted pollutants into the atmosphere. The LTC catalyst 20 is located downstream of the engine 11 at or near the position that is typically occupied by a muffler 12 and where the temperature of the engine exhaust gas stream is less than about 550° C., and preferably less than 500° C. The LTC catalyst 20 may be used as the sole conversion catalyst. However, in certain aspects of the invention, the LTC catalyst 20 will be used in conjunction with a conventional pollutant conversion catalyst 10 to ensure that the level of pollutant compounds exhausted to the atmosphere will be at an ultra low level, e.g., less than about 0.04 g/mile for hydrocarbons, less than about 1.7 g/mile for carbon monoxide, and less than about 0.2 g/mile for nitrogen oxides. In either case, however, the LTC catalyst 20 will be located toward the conventional muffler position (FIG. 2), or the tailpipe position (FIG. 3), where the temperature of the exhaust gas stream is relatively low, i.e., less than about 550° C., and preferably less than about 500° C., e.g., about 300° C.

The catalyst material of conversion catalyst 10 that optionally may be used as part of the present converter system may comprise any of the catalyst materials known in the art for converting the pollutants in an internal combustion engine exhaust stream to innocuous compounds. Conversion catalyst 10 is preferably a three-way catalyst (TWC). Typically, the catalyst 10 comprises a platinum group metal deposited on a refractory support material. The support material may comprise a high surface area refractory oxide, such as zirconia, ceria, titania, or the like. In one preferred embodiment, the support material may comprise alumina generally referred to in the art as “gamma alumina” or “activated alumina”, which typically exhibits a BET surface area in excess of about 60 square meters per gram (m²/g), often up to about 200 m²/g or more. Such activated alumina is usually a mixture of the gamma and delta phases of alumina, but also may contain substantial amounts of eta, kappa and theta alumina phases.

As is known in the art, the support material may be stabilized against thermal degradation. For example, when the support material is activated alumina, materials such as zirconia, titania, alkaline earth metal oxides such as baria, calcia or strontia, or rare earth metal oxides such as ceria, lanthana and mixtures of two or more rare earth metal oxides, may be added to the alumina to render the support stable at relatively higher temperatures. See, for example, U.S. Pat. No. 4,171,288. For a discussion of other support materials that may be used for the catalyst material 1, see application Ser. No. 08/682,174 (Docket No. 3777D), filed, Jul. 16, 1996. That application, which is entitled, “VEHICLE HAVING ATMOSPHERE POLLUTANT TREATING SURFACE”, and which is assigned to the assignee of this application, is incorporated herein by reference.

The platinum group metal component may be disposed on the support in a conventional manner, e.g., a solution comprising a soluble salt of one or more platinum group metals such as platinum or palladium may be impregnated into a powder comprising the support material. Water soluble compounds or complexes, as well as organic soluble compounds or complexes, or elemental dispersions also may be used. The only limitations on the liquids used to deposit these compounds, complexes, or elemental dispersions is that the liquids should not react with the metal materials and that they must be capable of being removed from the catalyst by volatilization or decomposition during subsequent calcination and/or vacuum treatment. Suitable-platinum group metal materials which may be deposited on the support material include, for example, palladium nitrate, palladium chloride, chloroplatinic acid, potassium platinum chloride, rhodium chloride, ammonium platinum thiocyanate, amine solubilized platinum hydroxide, hexamine rhodium chloride and similar decomposable compounds. The wetted support powder is dried and the platinum group metal compound is fixed onto the support in a catalytically active form.

The catalyst material of conversion catalyst 10 that may be used in the present invention may be employed in particulate form with particles in the micron-size range typically 1-20 microns, and more typically, about 10-20 microns in diameter. The particles may be formed into any convenient shape, such as pellets, granules, rings, spheres or short, extruded segments. In the alternative, the catalyst particles can be deposited, e.g., as a film or washcoat, onto a carrier material, preferably an inert monolithic carrier material, which provides a structural support for the catalyst material of conversion catalyst 10.

The carrier material may be any refractory material such as a refractory ceramic or ceramic-like material or a refractory metallic material. Preferably, the carrier material would not react with the catalyst and would not be degraded by the exhaust gas stream to which it is exposed. Examples of suitable ceramic or ceramic-like materials include zirconium oxide, zirconium mullite, spondumene, alumia-titanates, aluminum silicates, alumina-silica-magnesia, magnesium silicates, alpha-alumina, titania, cordierite, cordierite-alpha-alumina and the like. Metal carrier materials that may be used in the invention include, for example, stainless steel or other suitable iron-based alloys, which are oxidation resistant, and are otherwise capable of withstanding high temperatures and acidic corrosion.

The carrier material may best be utilized in a rigid configuration, such as a honeycomb-type configuration having a plurality of fine, parallel gas-flow passages or channels extending therethrough in the direction of gas flow from an inlet to an outlet face of the carrier. It is preferred that the configuration be a honeycomb-type configuration, either in a unitary form, or as an arrangement of multiple components or modules. When used, a honeycomb structure typically would be oriented such that the exhaust gas stream flows in the same direction as the cells or channels of the honeycomb structure. Typically, the flow passages or channels would be essentially straight from their fluid inlet to their fluid outlet, and would be defined by walls on which the catalyst material 10 would be coated as a “washcoat” so that the gases flowing through the passages contact the catalyst material. The flow passages of the carrier member are thin-walled channels which can be of any suitable size and cross-sectional shape., e.g., trapezoidal, rectangular, square, oval, circular, hexagonal, sinusoidal or the like. Such honeycomb-type carriers may contain from about 60 to about 1200 or more gas inlet openings (“cells”) per square inch of cross section (cpsi), more typically 200 to 600 cpsi. Generally, the coated carrier is disposed in a canister configured to protect the catalyst material and to facilitate establishment of a gas flow path through the cells and in contact with the catalyst material, as is known in the art. For a more detailed discussion of monolithic structures, refer, for example; to U.S. Pat. Nos. 3,785,998 and 3,767,453.

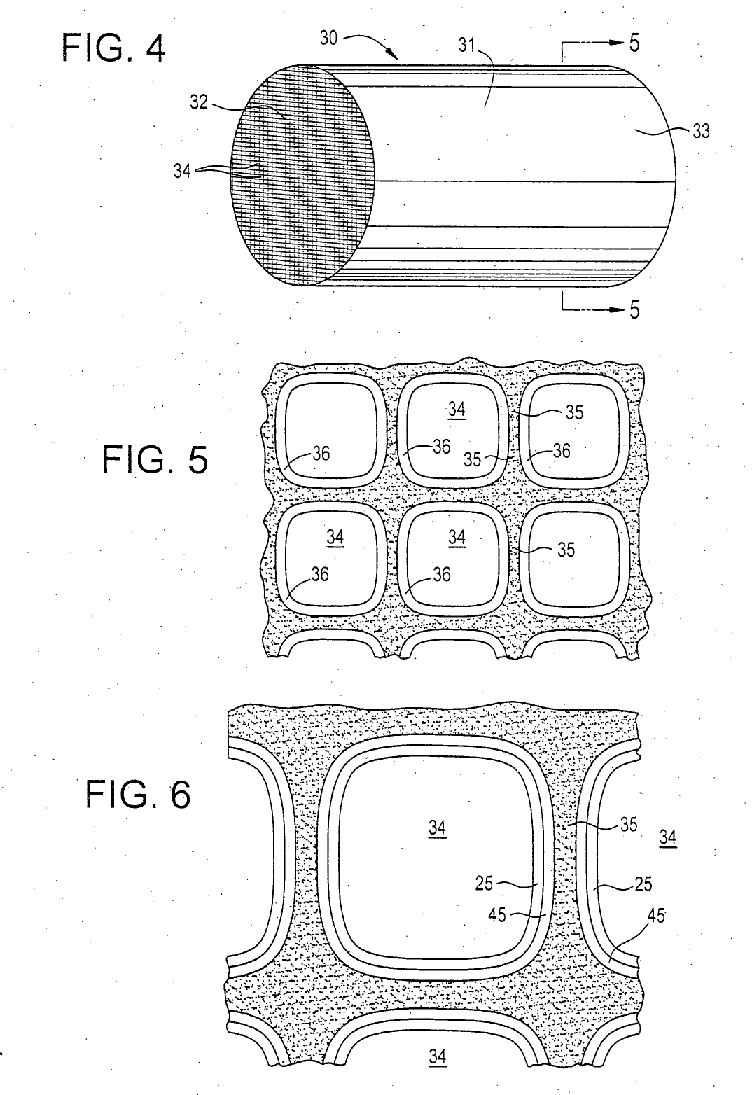

In one embodiment, as illustrated in FIG. 4., the catalyst material of conversion catalyst 10 is preferably supported on a honeycomb-type carrier member 30 of generally cylindrical shape having a cylindrical outer surface 31, a first or inlet end face 32 and a second or outlet end face, not visible in FIG. 4, which is identical to inlet end face 32. The junction of the outer surface 31 and the outlet end face at its peripheral edge portion is indicated as 33 in FIG. 4. As shown more clearly in FIG. 5, the carrier 30 has a plurality of fine, parallel gas flow passages 34 formed therein. The, gas flow passages 34 are defined by walls 35 and extend through the carrier 30 from inlet end face 32 to the outlet end face thereof, the passages 34 being unobstructed so as to permit the flow of a fluid, e.g., exhaust gas stream, longitudinally through the carrier via the gas flow passages 34 thereof. A coating 36, which in the art is sometimes referred to as a “washcoat”, is adhered to the walls 35 and may be comprised of a single layer of the catalyst material, or multiple layers of the same or different catalyst materials. The washcoat may be deposited onto the walls 35 of the honeycomb carrier by first mixing the catalyst material with water and a binder to form a washcoat slurry, followed by dipping the carrier into the slurry, removing excess slurry by draining or blowing out the channels of the honeycomb, and heating the coated honeycomb to drive off the water and to harden the resulting catalyst layer. The above process could be repeated, as necessary, to achieve the desired loading of catalyst material of conversion catalyst 10 on the carrier.

In an alternative embodiment, not shown in the drawings, the catalyst material 10 may be supported on a carrier material comprised of a body of beads, pellets or-particles (collectively referred to as “carrier beads”) made of a suitable refractory material such as gamma-alumina. A body of such carrier beads may be contained within a suitable perforated container that permits the passage of an exhaust gas stream therethrough.

When deposited as a washcoat onto a carrier, the amounts of the various components of the catalyst material of conversion catalyst 10 are often presented on a grams per volume basis, e.g., grams per cubic foot (g/ft³) for platinum group metal components and grams per cubic inch (g/in³) for catalytic materials generally, as these measures accommodate different gas flow passage sizes in different carriers, e.g., different-cell sizes in honeycomb-type carriers. For typical automobile exhaust gas catalytic converters, the catalyst material of conversion catalyst 10, when used, generally comprises from about 1.0 to about 5.5 g/in³, generally from about 2.0 to about 4.5 g/in³ of catalytic material washcoat on the carrier.

Typically, the catalyst material of conversion catalyst 10 functions as a TWC catalyst suitable for the conversion of hydrocarbons, carbon monoxide and nitrogen oxides to innocuous substances, e.g., H₂O, CO₂ and N₂.

As illustrated in FIGS. 2 and 3, the present catalytic converter system optionally, although preferably, comprises a hydrocarbon adsorbent or trap 40 comprising a hydrocarbon adsorbent material. Preferably, the trap is located downstream of the optional upstream conversion catalyst 10 and upstream of the low temperature catalyst 20. The trap 40 is designed to adsorb hydrocarbons from the exhaust gas stream while the engine is warming-up and to desorb the previously adsorbed hydrocarbons when the LTC catalyst 20 has reached a temperature above its light-off temperature. It will be appreciated, of course, that one or more additional adsorbent materials, e.g., for adsorbing-desorbing carbon monoxide, nitrogen oxides, water and/or sulfur dioxide optionally may be included in the system, as described in application Ser. No. ______ (not yet available) (Docket No. 3754), filed on even date herewith. That application Ser. No. ______ (Docket No. 3754), which is entitled, “NEAR ZERO EMISSION VEHICLE CATALYTIC CONVERTER SYSTEM FOR INTERNAL COMBUSTION ENGINE POWERED VEHICLES”, is assigned to the assignee of this application and the disclosure thereof is incorporated herein by reference.

The low temperature conversion catalyst 20 that is used in the present invention may comprise any low temperature conversion catalyst material that is capable of converting the pollutants in an internal combustion engine exhaust gas stream to innocuous compounds, and which has a light-off temperature less than about 200° C., and preferably less than about 100° C., e.g., about 70° C. Such low temperature conversion catalyst materials are disclosed in the above mentioned application Ser. No. 08/682,174 (Docket No. 3777D).

There is no limit on the efficiency of the LTC catalyst material of low temperature conversion catalyst 20 as long as it is capable of causing the desired conversion reactions to take place. Useful conversion efficiencies are preferably at least about 10% and more preferably at least about 20%. Preferred conversions depend on the particular pollutants being treated. For example, preferred conversion for carbon monoxide is greater than 10% and preferably greater than 30%. Preferred conversion, efficiency for hydrocarbons and partially oxygenated hydrocarbons is at least 5%, preferably at least 15%, and most preferably at least 25%. Preferred conversion efficiency for nitrogen oxides is at least 5%, preferably at least 15%, and most preferably at least 25%. These conversion rates are particularly preferred where the temperature of the exhaust gas stream contacting the catalyst surface is at less than about 550° C. These temperatures typically are experienced during normal engine operation when the catalyst is located in the muffler or tailpipe position. The conversion efficiency is based on the mole percent of the particular pollutants in the exhaust gas stream which react in the presence of the LTC catalyst composition.

LTC catalyst materials which are useful for converting carbon monoxide to carbon dioxide preferably comprise at least one precious metal component, preferably selected from platinum, rhodium and/or palladium components with platinum components being most preferred. A combination of a platinum component and a palladium component results in improved CO conversion at an and is most preferred where greater conversion is desired and cost increase is acceptable. The LTC catalyst compositions for converting carbon monoxide to carbon dioxide typically comprise from about 0.01 to about 20 weight percent, and preferably from about 0.5 to about 15 weight percent of the precious metal component on a suitable support such as refractory oxide support, with the amount of precious metal being based on the weight of precious metal (metal and not the metal component) and the support. Platinum is most preferred and is preferably used in amounts of from about 0.01 to 10 weight percent and more preferably 0.1 to 5 weight percent, and most preferably 1.0 to 5.0 weight percent. Palladium is useful in amounts from about 2 to about 15, preferably about 5 to about 15, and yet more preferably about 8 to about 12 weight percent. The preferred support is titania, with titania sol being most preferred. When loaded onto a monolithic structure such as a honeycomb refractory carrier, the catalyst loading is preferably about 1 to 150, and more preferably 10 to 100 grams of platinum per cubic foot (g/ft³) of catalyst volume and/or 20 to 1000 and preferably 50 to 250 grams of palladium per cubic foot of catalyst volume. A preferred composition comprises about 50 to 90 g/ft³ of platinum and 100 to 225 g ft³ of palladium. Preferred catalysts are reduced. Conversions of about 30 to about 100 mole percent of carbon monoxide to carbon dioxide can be achieved using a coated honeycomb refractory carrier having from about 1 to about 5 weight percent (based on metal) of platinum on titania compositions at temperatures from 25° C. to 100° C., where the carbon monoxide concentration in the exhaust stream being treated was 10 to 10,000 parts per million and the space velocity was 20,000 to 50,000 reciprocal hours. Conversions of about 0 to 70 mole percent of carbon monoxide to carbon dioxide can be attained using 1 to 5 weight percent platinum on alumina support compositions at a temperature of from about 50° C. to about 100° C., where the carbon monoxide concentration is about 10 parts per million and the space velocity is about 20,000 reciprocal hours.

LTC catalyst materials for converting hydrocarbons, typically unsaturated hydrocarbons, more typically unsaturated mono-olefins having from two to about twenty carbon atoms and, in particular, from two to eight carbon atoms, and partially oxygenated hydrocarbons, comprise at least one precious metal component, preferably selected from platinum and palladium with platinum being most preferred. The combination of a platinum component and a palladium component results in improved hydrocarbon conversion at an increase in cost and is most preferred where greater conversion is desired and cost increase is acceptable. Useful catalyst compositions include those described for use to treat carbon monoxide. Compositions for treating hydrocarbons typically comprise from about 0.01 to about 20 wt. %, and preferably 0.5 to 15 wt. %, of the precious metal component on a suitable support such as a refractory oxide support, with the amount of precious metal being based on the weight of the precious metal, (not the metal component) and the support. Platinum is the most preferred and is preferably used in amounts of from 0.01 to 10 wt. %, more preferably 0.1 to 5 wt. %, and most preferably 1.0 to 5 wt. %. When loaded onto a monolithic structure such as a refractory honeycomb carrier of the type illustrated in FIG. 4, the catalyst loading is preferably about 1 to about 150 and more preferably about 10 to about 100 grams of platinum per cubic foot (g/ft³) of catalyst volume. When platinum and palladium are used in combination, there is from about 0.25 to 100 g/ft³ of platinum and 50 to 250 g/ft³ of palladium. A preferred composition comprises about 50 to 90 g/ft³ of platinum and 100 to 225 g/ft³ of palladium. The preferred refractory oxide support is a metal oxide refractory that is preferably selected from ceria, silica, zirconia, alumina, titania and mixtures thereof with alumina and titania being most preferred. The preferred form of titania is a titania sol.

LTC catalyst materials useful for the oxidation of both carbon monoxide and hydrocarbons generally include those recited above as useful for treating either carbon monoxide or hydrocarbons. Most preferred catalysts that have been found to have good activity for the treatment of both carbon monoxide and hydrocarbons, such as unsaturated olefins, comprise a platinum component supported on a preferred titania support. Such catalyst compositions preferably comprise a binder and can be coated on a suitable support structure in amounts of from about 0.5 to about 1.0 g/in³. A preferred platinum concentration ranges from 2 to 6% and preferably 3 to 5% by weight of platinum metal on the titania support. Useful and preferred substrate cell densities are equivalent to about 200 to 600 cpsi.

Catalyst activity, particularly for treating carbon monoxide and hydrocarbons, can be further enhanced by reducing the catalyst in a forming gas such as hydrogen, carbon monoxide, methane or hydrocarbon plus nitrogen gas. Alternatively, the reducing agent can be in the form of a liquid such as a hydrazine, formic acid, and formate salts such as sodium formate solution. The catalyst can be reduced as a powder or after coating onto a carrier. The reduction can be conducted in gas at a temperature of from about 150° C. to about 500° C., preferably from about 200° C. to about 400° C. for 1 to 12 hours, preferably 2 to 8 hours. In a preferred process, a coated carrier can be reduced in a gas comprising from about 38% to about 7% hydrogen in nitrogen at from about 275° C. to about 350° C. for 2 to 4 hours.

Preferred LTC catalyst compositions, especially those containing a catalytically active component such as a precious metal catalytic component, comprise a suitable support material such as a refractory oxide support. The preferred refractory oxide can be selected from the group consisting of silica, alumina, titania, ceria, zirconia and chromia, and mixtures thereof. More preferably, the support is at least one activated, high surface area compound selected from the group consisting of alumina, silica, titania, silica-alumina, silica-zirconia, alumina silicates, alumina zirconia, alumina-chromia and alumina-ceria. The refractory oxide can be in any suitable form including bulk particulate form typically having particle sizes ranging from about 0.1 to about 100 and preferably 1 to 20 microns (μm), or in sol form also having a particle size ranging from about 1 to about 50 and preferably about 1 to about 20 nm. A preferred titania sol support comprises titania having a particle size ranging from about 1 to about 10, and typically from about 2 to 10 nm.

Also useful as a preferred support is a coprecipitate of a manganese oxide and zirconia. This composition can be made as recited in U.S. Pat. No. 5,283,041, the disclosure which is incorporated herein by reference. Briefly, this coprecipitated support material preferably comprises in a ratio based on the weight of manganese and zirconium metals from 5:95 to 95:5; preferably 10:90 to 75:25; more preferably 10:90 to 50:50; and most preferably from 15:85 to 50:50. A useful and preferred embodiment comprises a Mn:Zr weight ratio of 20:80. U.S. Pat. No. 5,283,041 describes a preferred method for making a coprecipitate of a manganese oxide component and a zirconia component. As recited in U.S. Pat. No. 5,283,041, a zirconia oxide and manganese oxide material may be prepared by mixing aqueous solutions of suitable zirconium oxide precursors such as zirconium oxynitrate, zirconium acetate, zirconium oxychloride, or zirconium oxysulfate and a suitable manganese oxide precursor such as manganese nitrate, manganese acetate, manganese dichloride or manganese dibromide, adding a sufficient amount of a base such as ammonium hydroxide to obtain a pH of 8-9, filtering the resulting precipitate, washing with water, and drying at 450° C.-500° C.

Useful refractory oxide supports for a catalyst comprising a platinum group metal to treat carbon monoxide are selected from alumina, titania, silica-zirconia, and manganese-zirconia. Preferred supports for a catalyst composition to treat carbon monoxide is a zirconia-silica support as recited in U.S. Pat. No. 5,145,825, a manganese-zirconia support as recited in U.S. Pat. No. 5,283,041 and high surface area-alumina. Most preferred for treatment of carbon monoxide is titania. Reduced catalysts having titania supports resulted in greater carbon monoxide conversion than corresponding-non reduced catalysts.

The support for catalyst for treating hydrocarbons, such as low molecular weight hydrocarbons, particularly low molecular weight olefinic hydrocarbons having about from two up to about twenty carbons and typically from two to about eight carbon atoms, as well as partially oxygenated hydrocarbons preferably is selected from refractory metal oxides including alumina and titania. As with catalysts to treat carbon monoxide reduced catalysts results in greater hydrocarbon conversion. Particularly preferred is a titania support which has been found useful since it results in a catalyst composition having enhanced ozone conversion as well as significant conversion of carbon monoxide and low molecular weight olefins. Also useful are high surface area, macroporous refractory oxides, preferably alumina and titania having a surface area of greater than 150 m²/g and preferably ranging from about 150 to 350, preferably from 200 to 300, and more preferably from 225 to 275 m²/g; a porosity of greater than 0.5 cc/g, typically ranging from 0.5 to 4.0 and preferably about from 1 to 2 cc/g measured based on mercury porosometry; and particle sizes range from 0.1 to 20 μm. A useful material is high alumina having a surface area of from about 150 to 300 m²/g and a porosity of 0.4 to 1.5 cc/g.

A preferred refractory support for platinum group metals, preferably platinum and/or palladium for use in treating carbon monoxide and/or hydrocarbons is titania dioxide. The titania can be used in bulk powder form or in the form of titania dioxide sol. Also useful is nano particle size (nanometer) titania. The catalyst composition can be prepared by adding a platinum group metal in a liquid media, preferably in the form of an amine solubilized platinum hydroxide solution, with the titania sol. The obtained slurry can then be coated onto a suitable substrate such as a ceramic honeycomb carrier or other refractory substrate. The preferred platinum group metal is a platinum compound. The platinum titania sol catalyst obtained from the above procedure has high activity for carbon monoxide and/or hydrocarbon oxidation at ambient operating temperature. Metal components other than platinum components which can be combined with the titania sol include gold, palladium, rhodium, silver and mixtures thereof. A reduced platinum group component, preferably a platinum component on titanium catalyst which is indicated to be preferred for treating carbon monoxide, has also been found to be useful and preferred for treating hydrocarbons, particularly olefinic hydrocarbons. Alternatively, the slurry can be made without any or all of the platinum group metal component and coated as a washcoat on the substrate. A solution of a platinum group metal component can be sprayed, dip coated, or otherwise coated onto the washcoat located on the substrate after the washcoat has been dried and/or calcined.

A preferred titania sol support comprises titania having a particle size ranging from about 1 to about 20, and typically from about 2 to 5 nm.

A preferred bulk titania has a surface area of about from 10 to 120 m²/g, and preferably from 25 to 100 m²/g. A specific and preferred bulk titania support has a surface area of 45-50 m²/g, a particle size of about 1 μm. Useful nano particle size titanium comprises having a particle size ranging from about 5 to 100 and typically greater 10 to about 50 nm.

As shown in FIGS. 2 and 3, a trap 40 is disposed downstream of the catalyst material 10 for adsorbing hydrocarbon pollutants during the cold-start period of engine operation. A single trap containing an appropriate adsorbent material for reversibly adsorbing-desorbing hydrocarbons is shown. However, it will be appreciated that additional traps may be employed for adsorbing other pollutants, and that the adsorbents may be selected such that the adsorbed pollutants become desorbed, thereby regenerating the adsorbents, once the optional catalyst material 10, or the LTC catalyst 20, has warmed sufficiently to convert efficiently the pollutants contained in the exhaust gas stream.

Adsorbents for hydrocarbons and other pollutants in the exhaust gas stream are not novel, per se; and they do not, in and of themselves, comprise the present invention. It is the use and location of such adsorbents, in combination with an appropriate low temperature conversion (LTC) catalyst material 20, and the location of the LTC catalyst at a position where the temperature of the exhaust gas stream does not exceed about 550° C., and preferably 500° C. that comprises the invention.

Adsorbents which are useful for adsorbing-desorbing hydrocarbons present in the engine exhaust stream, in preference to other exhaust gas components, including water, are well known and include, for example, hydrothermally stable molecular sieve materials such as silicalite, faujasites, clinoptilonites, mordenites and chabazite.

By “hydrothermally stable” is meant the ability of the molecular sieve to maintain its structure after thermal cycling in the exhaust gas stream. One method of measuring the hydrothermal stability is to look at the temperature at which 50% of the structure is decomposed after heating for 16 hours. That temperature is referred to as T(50). Accordingly, as used in this application, a hydrothermally stable molecular sieve is meant to describe a molecular sieve which has a T(50) of at least 750° C.

The hydrocarbon adsorbents suitable for use in this invention must adsorb hydrocarbons in preference to water. In other words, suitable adsorbents must have a hydrocarbon selectivity (∝) greater than 1, wherein ∝ is defined by the following equation:

$${∝}_{HC - H2O} = \frac{{X}_{HC}}{{X}_{H2O}} \cdot \frac{[ {H}_{2} O ]}{[ HC ]}$$

wherein

X_{MC}=the hydrocarbon co-loading on the adsorbent in equilibrium with the hydrocarbon vapor and water vapor mixture in the gas phase over the adsorbent;

X_{HZO}=the water co-loading on the adsorbent in equilibrium with the hydrocarbon vapor and water vapor mixture in the gas phase over the adsorbent;

[H₂O]=the concentration of the water vapor in the exhaust gas stream; and

[HC]=the concentration of the hydrocarbon vapor in the exhaust gas stream.

A further discussion of the hydrocarbon selectivity of molecular sieve materials in context of the above equation is found beginning at column 5, line 31 of U.S. Pat. No. 5,078,979, the disclosure of which is incorporated herein by reference.

Both natural and synthetic molecular sieve materials may be used as hydrocarbon adsorbents in the present catalytic converter system. Examples of suitable natural molecular sieves include, for example, faujasites, clinoptilolites, mordenites, and chabazite. Examples of synthetic molecular sieve materials include silicalite, zeolite Y, ultra stable zeolite Y, β-zeolite, metal exchanged β-zeolites such as Cu-exchanged O-zeolites and Ag-exchanged β-zeolites, and ZSM-5. Particularly suitable hydrocarbon adsorbents are those disclosed in PCT application number PCT/US 93/11312, WO 94/11623, published May 26, 1994, entitled, “METHOD AND APPARATUS FOR TREATING AN EXHAUST GAS STREAM”. That application is assigned to the assignee of this application and its disclosure is incorporated herein by reference.

The carrier material used for supporting the hydrocarbon adsorbent material 40 (and/or any adsorbent that might be used in the present converter system) may be a refractory material such as a refractory ceramic or ceramic-like material or a refractory metallic material. Preferably, the carrier material would not react with the hydrocarbon adsorbent and would not be degraded by the exhaust gas stream to which it is exposed. Suitable carrier materials include, for example, zirconium oxide, zirconium mullite, spondumene, alumia-titanates, aluminum silicates, alumina-silica-magnesia, sillimanite, magnesium silicates, alpha-alumina, titania, cordierite, cordierite-alpha-alumina, stainless steel or other suitable iron-based alloys, which are oxidation resistant and are otherwise capable of withstanding high temperatures.

The carrier material may best be utilized in a rigid configuration, such as a honeycomb-type configuration, as described above in connection with the refractory carriers on which the catalyst material 10 and the LTC catalyst 20 may be coated. When the hydrocarbon adsorbent is coated on a honeycomb-type carrier, it may be coated on a carrier that is separate from that which the catalyst material (10) or the LTC material (20) is coated. In that case, the hydrocarbon adsorbent material may be described as comprising at least a portion of the trap 40 shown in FIGS. 2 and 3. However, in certain alternative embodiments of the invention, the same honeycomb-type carrier may be coated with either or both of the catalyst material (10) and the LTC catalyst material (20), and also with the hydrocarbon adsorbent material (40). In those embodiments, as illustrated, for example, in FIG. 6, the catalyst material 25 including at least one layer of the catalyst material (10) and/or at least one layer of the low temperature catalyst material (20) and the hydrocarbon adsorbent material 45 may be applied, for example, as separate washcoat layers 25 (catalyst material) and 45 (hydrocarbon adsorbent material or trap material) respectively, on the walls 35 of the honeycomb cells, in the manner described above in connection with the catalyst 10. Typically, when the catalyst material (20) and the hydrocarbon adsorbent material (40) are applied as separate layers on the same honeycomb-type carrier, the catalyst layer 25 is deposited on top of the adsorbent layer 45 as a porous overlayer. To provide a suitably porous overlayer, the total loading of catalyst material overlying the adsorbent material preferably does not exceed about 5 g/in³. For example, the catalyst layer 20 may be applied at a loading of from about 2 to 4.5 g/in³, preferably about 3.5 g/in³. In addition to providing a permeable catalytic overlayer, the application of loadings of catalytic material in this range will avoid imparting a significant pressure drop in the exhaust gas stream flowing through the honeycomb carrier member. Typically, the hydrocarbon adsorbent material 40 is coated onto the carrier at a loading of from about to about 0.4 to about 3.0 g/in³. Optionally, the overlayer of catalyst material 20 may be coated onto the carrier as a series of two or more discrete layers of the same or different catalyst material, one upon the next, over, under, or between one or more discrete layers of hydrocarbon adsorbent material 45.

In an alternative embodiment, not shown in the drawings, the hydrocarbon adsorbent material (40) may be deposited on a particulate carrier, referred to as “carrier beads”. As described above in connection with the catalyst material (10), a body of such carrier beads may be contained within a suitable perforated container which permits the passage of an exhaust gas stream therethrough.

The amount of hydrocarbon adsorbent used in the present converter system is selected such that at least about 30%, and preferably at least about 50%, of the hydrocarbons in the exhaust stream from the engine during the warm-up period is adsorbed. When the adsorbent is deposited on a monolithic honeycomb carrier, the amount of adsorbent on the carrier typically varies from about 0.5 to about 2.5 g/in³.

It is desirable to optimize the amount of hydrocarbon adsorbent that is used such that the catalyst material (20) downstream of the hydrocarbon adsorbent is heated as quickly as possible while at the same time ensuring that at least about 50% of the hydrocarbons in the exhaust stream are adsorbed on the hydrocarbon adsorbent. It is preferred that the adsorbent be deposited on a monolithic honeycomb carrier in order to minimize the size of the adsorbent mass and the back pressure exerted on the engine.

The present invention is illustrated further by the following examples that are not intended to limit the scope of this invention.

### EXAMPLE 1

### Catalyst Preparation

A porous titania powder having a BET surface area of about 70 m²/g was used as a catalyst support. On 778 g of the titania powder, 117.6 g of amine solubilized platinum (Pt) hydroxide solution containing 21.6 g of Pt was impregnated in a P-mixer. The wet powder was transferred into a container where sufficient deionized water was added to form a slurry containing about 40% solids. Next, 78 g of zirconia binder and 18.6 g of alumina binder were added into the slurry and thoroughly mixed. The slurry was washcoated onto a precoated monolithic ceramic to obtain a dry gain of 1.7 grams per cubic inch (gci) loading, excluding the precoat. The precoated layer was composed of zeolite material with 15% amorphous silica and zirconia binders totaling 1.05 gci. Each washcoated catalyst layer was dried at 110° C. overnight, and calcined at 400° C. for 2 hours. The final double layered catalyst comprised a monolithic ceramic coated with a layer of zeolite and overcoated with a layer of Pt on titania catalyst.

### EXAMPLE 2

### Catalyst Preparation

A trimetal catalyst layer was added onto the double layered catalyst of Example 1 to make a triple layered catalyst. To form the proper slurry for this trimetal catalyst, an amine solubilized platinum hydroxide solution which contained 2.58 g Pt was added to 279 g of alumina powder having a BET surface area of about 230 m²/g in a P-mixer. After the Pt was added, rhodium (Rh) was introduced into the same alumina powder as a rhodium nitrate solution which contained 5.16 g of Rh.

In another P-mixer, an amine solubilized platinum hydroxide solution which contained 2.58 Pt was added to 334 g of bulk ceria oxide.

In the third P-mixer, palladium (Pd), as a palladium nitrate solution which contained 20.9 g Pd, was added into 278.6 g of the same type of alumina described above. The Pd-containing powder was dried and calcined at 550° C. for 1 hour after impregnation.

The powders of the previously mentioned three P-mixers were combined with 28 g of barium oxide precursor, 44.6 g of zirconia binder, and a sufficient amount of deionized water to form a slurry containing 43.5 solids. The slurry was washcoated onto a precoated monolithic ceramic substrate as described in Example 1. The resulting catalyst was dried overnight at 110° C., and calcined at 450° C. for 2 hours to form a triple layered catalyst comprised of a Pt/Pd/Rh layer over a PT on titania layer over a zeolite layer on a monolithic ceramic carrier.

### EXAMPLE 3

### Catalyst Preparation

A double layered catalyst was prepared by washcoating a titania powder support having a layer of zeolite material (1.05 gel as described in Example 1) with a top layer of trimetal catalyst (1.8 gci as described in Example 2).

### EXAMPLE 4

### Exhaust Gas Treatment

In a series of test runs, the catalysts prepared in accordance with Examples 1-3 were used to treat an internal engine vehicle exhaust gas containing unburned hydrocarbons, carbon monoxide and nitrogen oxide pollutants. The respective catalysts were positioned downstream of the vehicle engine either in the underfloor (UF) position well upstream of the normal muffler position (where the exhaust gas temperature was in excess of 550° C. during normal engine operation), in the tailpipe position (TP1) just upstream of the normal muffler position (where the temperature of the exhaust gas was less than 500° C.), or in the tailpipe position (TP2) downstream of the muffler (where the exhaust gas temperature was less than about 200° C.). The percent conversion of the hydrocarbon, CO and NOₓ pollutants was measured for each test run. For test run numbers 3, 4 and 6, the catalyst was reduced prior to use by heating the catalyst in the presence of 4% H₂/96% N₂ atmosphere at about 300° C. for 3 hours. The results of the test runs are shown in the following table.

| Run | | | Conversion (%) | | |
|---|---|---|---|---|---|
| No. | Catalyst | Position | HC | CO | NOₓ |
| 1 | Example 1 | TP2 | 27 | 6 | 0 |
| 2 | Example 1 | TP1 | 59 | 65 | 60 |
| 3 | Example 1* | TP1 | 77 | 87 | 65 |
| 4 | Example 1* | UP | 88 | 84 | 74 |
| 5 | Example 2 | TP1 | 31 | 40 | 32 |
| 6 | Example 2* | TP1 | 90 | 93 | 92 |
| 7 | Example 3 | TP1 | 87 | 87 | 93 |
| 8 | Example 3 | UF | 92 | 91 | 96 |

*= catalyst reduced prior to use.

The data in the table indicates that the conversion efficiency of the Pt/titania on zeolite/monolith catalyst prepared in accordance with Example 1 was relatively low (Run No. 1) when the catalyst was positioned in the tailpipe position (TP2) downstream of the muffler where the maximum temperature of the catalyst was about 180° C.; whereas the conversion increased dramatically when the catalyst was moved to a tailpipe position (TP1) slightly upstream of the normal muffler position, where the maximum catalyst temperature was about. 480° C. (Run No. 2). The conversion efficiency of the catalyst of Example 1 at the TP1 position was improved even further when the catalyst was subjected to a reduction treatment prior to use (Run No. 3). When the catalyst of Example 1 was moved upstream to the underfloor position; (UF), where the exhaust gas temperature was about 685° C. (Run No. 4) the conversion efficiency was increased still further. However, this latter improvement in efficiency will be short-lived inasmuch as high temperature operation (in excess of about 550° C.) will deactivate the platinum in the catalyst in a relatively short time.

Run Nos. 5 and 6 corroborate the considerable improvement in conversion efficiency that can be achieved by subjecting the catalysts of this invention to a reduction treatment prior to use. For these runs, the triple layered catalyst-prepared in accordance with Example 2 was located in the TP1 position only slightly upstream of the muffler position, such that the maximum catalyst-temperature was only about 380° C. (as opposed to 480° C. for Run No. 2). Run No. 6 illustrates the very high conversion efficiencies which can be achieved by subjecting the catalysts of the invention to a reduction treatment prior to use and by positioning the catalysts where they will be subjected to temperatures less-than about 550° C. (e.g., only about 380° C. in the case of Run No. 6).

Run Nos. 7 and 8 illustrate still further that conversion efficiencies approaching those of high temperature operation can be achieved by positioning the catalysts of this invention in the tailpipe position (TP1) where the maximum catalyst temperature is less than 550° C., and preferably less than 500° C. (Run No. 7); and in Run No. 8, the maximum catalyst temperature at the underfloor position is about 700° C.

While the invention has been described in detail with reference to particular embodiments thereof, it will be apparent that upon reading and understanding the foregoing, numerous modifications to the described embodiments will occur to those skilled in the art and it is intended to include such modifications within the scope of the appended claims.

What is claimed is:

1. A catalytic converter system suitable for catalyzing the conversion of hydrocarbons, carbon monoxide, nitrogen oxides and other pollutants contained in a flowing exhaust gas stream, the converter system comprising:
a low temperature conversion catalyst material comprising a platinum group metal component dispersed on a refractory support material, said low temperature conversion catalyst material having a light-off temperature T_{L} of less than about 200° C., and being located relative to the flowing exhaust gas stream such that said low temperature conversion catalyst material is never exposed to a temperature in excess of about 550° C.;
a hydrocarbon adsorbent material deposited on a refractory carrier, said hydrocarbon adsorbent material being capable of adsorbing hydrocarbons present in said flowing exhaust gas stream and of desorbing the adsorbed hydrocarbons when the temperature of said low temperature conversion catalyst material has exceeded said light-off temperature thereof; and
optionally, an upstream conversion catalyst material, said upstream conversion catalyst material, when present, being located upstream of said low temperature conversion catalyst material relative to the direction of flow of said flowing exhaust gas stream.

2. The converter system of claim 1, wherein both said low temperature conversion catalyst material and said hydrocarbon adsorbent material are deposited on said refractory carrier.

3. The converter system of claim 1, wherein said low temperature conversion catalyst is disposed in the muffler position under the floor of an internal combustion engine powered vehicle.

4. The converter system of claim 1, wherein said low temperature conversion catalyst is disposed in the tailpipe position under the floor of an internal combustion engine powered vehicle.

5. The converter system of claim 1, wherein said low temperature conversion catalyst material comprises platinum supported on titania; wherein said low temperature conversion catalyst material has been reduced to enhance its activity for converting hydrocarbons and carbon monoxide to innocuous compounds; wherein said adsorbent material comprises a hydrothermally stable molecular sieve material having a T(50) of at least about 750° C., a hydrocarbon selectivity greater than 1, and a Si/Al ratio of at least about 10; and wherein said low temperature conversion catalyst material is located relative the flowing exhaust gas stream such that it never is exposed to a temperature in excess of about 500° C.

6. The converter system of claim 1, which comprises said optional upstream conversion catalyst material.

7. The converter system of claim 5, which comprises said optional upstream conversion catalyst material.

8. The converter system of claim 3, wherein said low temperature conversion catalyst material and said adsorbent material are disposed in separate layers on muffler plates located in the path of the flowing exhaust gas stream; and wherein said low temperature conversion catalyst material is never exposed to a temperature in excess of about 500° C.

9. The converter system of claim 3, wherein said low temperature conversion catalyst material and said adsorbent material are disposed in separate layers on said refractory carrier and are located relative to the flowing exhaust gas stream such that said low temperature conversion catalyst material is never exposed to a temperature in excess of about 300° C.

10. The converter system of claim 2, wherein said refractory carrier is in the form of a honeycomb-type configuration; and wherein said low temperature conversion catalyst material and said adsorbent material are present in separate layers deposited on the cell walls of said honeycomb-type configuration.

11. The converter system of claim 2, wherein said refractory carrier is in the form of a honeycomb-type configuration; and wherein said low temperature conversion catalyst material and said adsorbent material are both present in the same layer deposited on the cell walls of said honeycomb-type configuration.

12. The converter system of claim 3, wherein said refractory carrier is in the form of a honeycomb-type configuration; and wherein said low temperature conversion catalyst material and said adsorbent material are present in separate layers deposited on the cell walls of said honeycomb-type configuration.

13. The converter system of claim 3, wherein said refractory carrier is in the form of a honeycomb-type configuration; and wherein said low temperature conversion catalyst material and said adsorbent material are both present in the same layer deposited on the cell walls of said honeycomb-type configuration.

14. The converter system of claim 3, wherein said low temperature conversion catalyst material and said adsorbent material are both present in the same layer deposited on muffler plates located in the path of the flowing exhaust gas stream; and wherein said low temperature conversion catalyst material is never exposed to a temperature in excess of about 500° C.

15. The converter system of claim 3, wherein said low temperature conversion catalyst material and said adsorbent material are both present in the same layer deposited on said refractory carrier; and wherein said refractory carrier is located relative to the flowing exhaust gas stream such that said low temperature conversion catalyst material never is exposed to a temperature in excess of about 300° C.

16. A method for reducing the pollutant emissions in the exhaust gas of an internal combustion engine, at least during a cold-start period of engine operation, comprising flowing the exhaust gas through an exhaust system comprising the catalytic converter system of any one of claims 1, 3, 4 and 5.

17. The converter system of any one of claims 1, 3, 4 and 5, wherein there is from about 10 to about 1000 g/ft³ of said platinum group metal in said low temperature conversion catalyst material.

18. The converter system of claim 17, wherein said low temperature conversion catalyst and said hydrocarbon adsorbent material are supported on the same refractory carrier, said refractory carrier being in the form of a honeycomb-type configuration.

19. The converter system of claim 18, wherein said low temperature conversion catalyst material and said adsorbent material are deposited, in separate layers on said refractory carrier.

20. The converter system of claim 17, wherein said low temperature conversion catalyst material has a light-off temperature of from about 70° C. to about 100° C.

21. The method of claim 16, wherein said temperature conversion catalyst material has a light-off temperature of less than about 100° C.; and wherein said low temperature conversion catalyst material is disposed relative to the flowing exhaust gas stream such that it never is exposed to a temperature in excess of about 500° C.
